(19) United States
(12) Patent Application Publication
(10) Pub. No.: US 2012/0144294 A1
(43) Pub. Date: Jun. 7, 2012

(54) ASSISTING DOCUMENT CREATION

(75) Inventors: Takehiko Amano, Kawasaki City (JP); Yoshio Horiuchi, Hiratsuka (JP); Ken Kumagai, Yamato (JP)

(73) Assignee: International Business Machines Corporation, Armonk, NY (US)

(21) Appl. No.: 13/298,111

(22) Filed: Nov. 16, 2011

(30) Foreign Application Priority Data
Dec. 1, 2010 (JP) 2010-268815

(51) Int. Cl. G06F 17/00; G06F 11/30

(52) U.S. Cl. 715/255

(57) ABSTRACT

Provided is a document creation assisting method, a document creation assisting system, and a document creation assisting program suitable to ensure consistent use of terms in document creation. Client processing is monitored to enable extracting one or more terms from a writing field of a document created by a user, and a terminology file is stored, where this terminology file includes a list of one or more standard terms that are the one or more terms thus extracted. Editing input assistance is provided, comprising extracting a term from a different writing field of a document being created by a user, locating from the terminology file a standard term that completely or partially matches the extracted term, and teaching the user the presence of the standard term located from the terminology file.

### BACKGROUND

The present invention relates to assisting document creation, and more particularly to ensuring consistent use of terms in document creation.

People create documents for various purposes so that each document will be suitable for its purpose.

In some cases, several people create a document for a certain purpose in collaboration. For example, several people may create a document together while each being in charge of a different chapter of the document.

Creating a document in such a manner requires ensuring consistency of descriptive patterns and terms, for example.

In software development by a team, several developers edit a single file or document, or a series of separate files or documents. For example, in team development under a collaboration environment such as Jazz™, several developers create and edit a single file or document, or a series of separate files or documents. (“Jazz” is a trademark of International Business Machines Corporation in the United States, other countries, or both.)

In a different situation, a company edits a document for the on-line help for their product, for example.

In such an editing process, terms need to be used consistently in the writing fields of a file or document. For example, terms should be consistently used in the writing fields of different chapters of a document.

To this end, in creating text for Chapter 3 of a document, for example, an attempt is made to use terms appearing in the writing fields of the chapters that have already been created.

Such a process for making terms consistent requires a lot of effort, and usually costs a lot for such efforts.

The process includes, for example, creating in advance a term list of terms considered to be necessary, and occasionally obtaining editing results from other developers working in collaboration. Furthermore, the term list and the editing results are typically updated as the process proceeds, and are hence subjected to minor additions and modifications on those occasions.

Such being the case, a framework has been desired that allows a user to reuse words and terms already used in the writing field of a document, more easily than ever.

### BRIEF SUMMARY

The present invention assists document creation, ensuring consistent use of terms, and may be provided, by way of example, as methods, systems, or computer programs comprising computer instructions.

In one aspect, the present invention comprises assisting a plurality of users to individually create one or more documents having consistent use of terms. This preferably comprises monitoring client processing of document creation and assisting with editing input. The monitoring preferably comprises extracting one or more terms from a writing field of a first document created by a first user, and storing the extracted one or more terms, as “standard” terms, in a terminology file on a storage device or in memory. The assisting preferably comprises extracting an input term from a writing field of a document being created by a user. This document may be the same document created by the first user, and this user maybe the same, or different, from the first user. The assisting preferably further comprises reading out the standard term completely or partially matching with the extracted input term from the terminology file stored in the storage means (that is, locating a previously-stored standard term that completely or partially matches the input term) and teaching the user the presence of the standard term thus read out.

Accordingly, the user can use the input term consistently by referring to the located standard term.

The present invention includes all the modes according to embodiments disclosed herein, including combinations of two or more of the disclosed embodiments.

A document creation assisting method, a document creation assisting system, and a document creation assisting program according to the present invention provide at least the following effects with various configurations.

In one aspect, a term extracted from a writing field of a document being created by a user is stored in a terminology file as a standard term, and the presence of a standard term completely or partially matching with a term extracted from a writing field of a document being created by a user is taught to the user. With this configuration, the user can use the term consistently by referring to the standard term, the presence of which is thus taught.

Moreover, creation of a document by a user may be monitored.

In a further aspect, creation of a document by a user by inputting an input code string through an input device and thereby confirming a term is monitored, a standard term and an input code string associated with each other are stored in a character-string pair file, an input code inputted by a user through an input device is read by monitoring the input process, an input code string completely or partially matching with the input code string thus read is read out from the character-string pair file, and the presence of the standard term associated with the input code string thus read out is taught to the user. With this configuration, the user can use the term consistently by referring to the standard term, the presence of which is thus taught.

In a still further aspect, a term adopted by a user as an adopted term from standard terms taught to the user is stored in a development history file, the adopted term thus stored and stored standard terms are compared at a predetermined timing, and the user is notified of the presence of the adopted term when no standard term completely matching with the adopted term is found. With this configuration, the user can use the term consistently by referring to the standard term no longer matching with the adopted term.

In still another aspect, an adopted term adopted by a user from standard terms taught to the user is stored in a development history file as an adopted term in association with a code string inputted at the time of confirming the adopted term, the adopted term thus stored and stored standard terms are compared at a predetermined timing, and the user is notified of the presence of the adopted term when no pair of the adopted term and a standard term completely matching with each other and associated respectively with input code strings completely or partially matching with each other is found. With this configuration, the user can use the term consistently by referring to the standard term no longer matching with the adopted term.

In yet another aspect, a document being created by a user is stored, a term extracted from a writing field of the document being created by the user is stored in a terminology file as a standard term, an evaluation value is calculated for each standard term stored in the terminology file, on the basis of the mode in which the standard term appears in the writing field of the stored document, an adopted term adopted by the user from standard terms taught to the user and the evaluation value of the adopted term are stored in a development history file by being associated with each other, the adopted term thus stored and stored standard terms are compared at a predetermined timing, and the presence of the adopted term is taught to the user when the evaluation value associated with the adopted term and the evaluation value associated with a standard term, the adopted term and the standard term completely matching with each other, do not match with each other. With this configuration, the user can use the term consistently by referring to the standard term the evaluation value of which no longer matches with that of the adopted term.

In a still further aspect, a term included in a writing field of a document being created by a user and not included in a dictionary is stored in a terminology file as a standard term. With this configuration, the term not included in a dictionary can be stored in a terminology file as a standard term.

### BRIEF DESCRIPTION OF THE SEVERAL VIEWS OF THE DRAWINGS

FIG. 1 is a view showing a process of a document creation assisting method according to a first embodiment of the present invention.

FIG. 2 is a view showing a process of a document creation assisting method according to a second embodiment of the present invention.

FIG. 3 is a schematic diagram showing a document creation assisting system according to an embodiment of the present invention.

FIG. 4 is a functional block diagram of a document creation assisting program according to the first embodiment of the present invention.

FIG. 5 is a functional block diagram of a document creation assisting program according to the second embodiment of the present invention.

FIG. 6 is a schematic view of the document creation assisting method according to embodiments of the present invention.

FIG. 7 is a first view illustrating an operation of the document creation assisting method according to embodiments of the present invention.

FIG. 8 is a second view illustrating the operation of the document creation assisting method according to embodiments of the present invention.

FIG. 9 is a third view illustrating the operation of the document creation assisting method according to embodiments of the present invention.

FIG. 10 is a fourth view illustrating the operation of the document creation assisting method according to embodiments of the present invention.

FIG. 11 is a fifth view illustrating the operation of the document creation assisting method according to embodiments of the present invention.

FIG. 12 is a sixth view illustrating the operation of the document creation assisting method according to embodiments of the present invention.

### DETAILED DESCRIPTION

Modes to carry out the present invention will be described below with reference to the drawings.

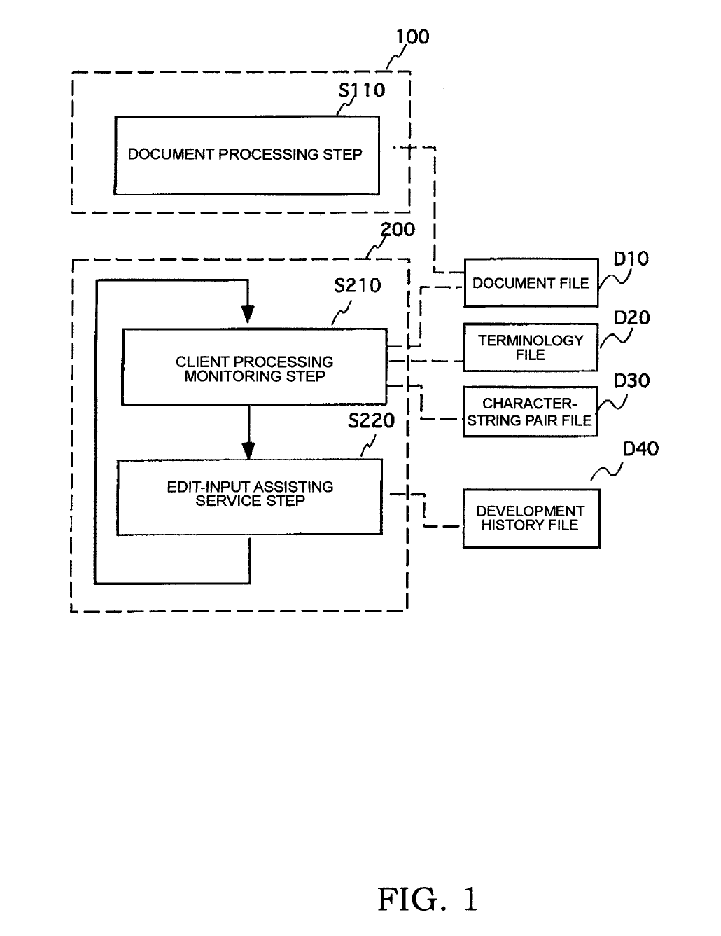

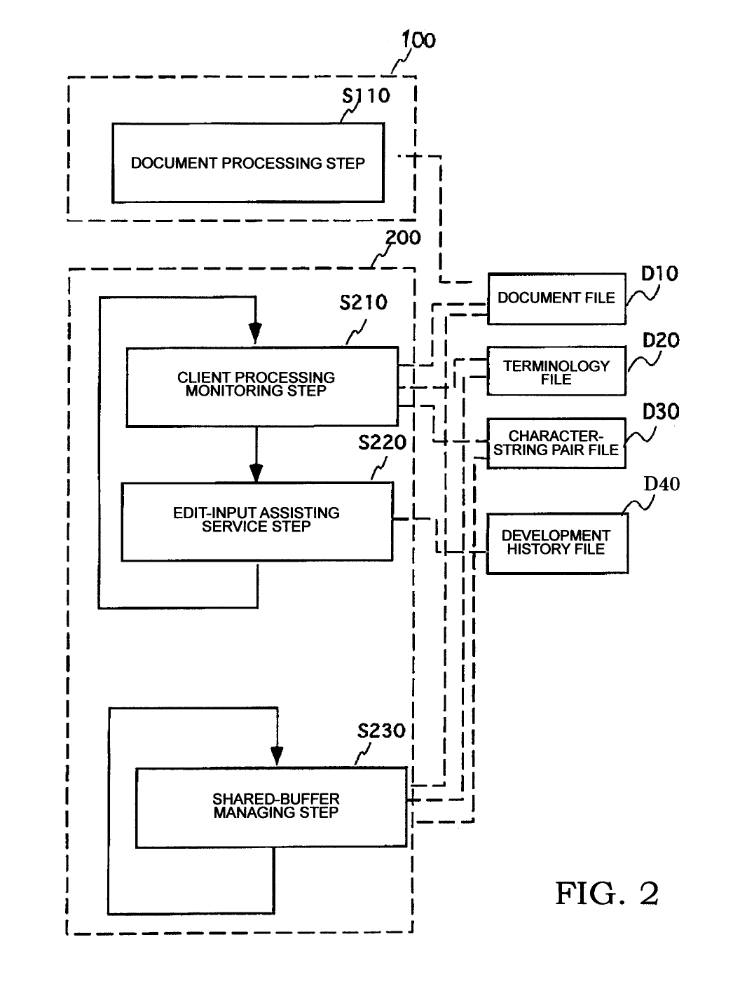

Referring now to FIGS. 1 and 2, a document creation assisting method 200 according to embodiments of the present invention is performed in parallel with performing a document processing method 100.

The document processing method 100 is a method of allowing a single or multiple users to create a single or multiple documents.

The document processing method 100 includes Step S110 of processing a single or multiple documents.

For example, in the document processing step S110, each document is subjected to processing according to an instruction inputted by a user, and a document file D10 is outputted.

The document creation assisting method 200 is a method of assisting a single or multiple users in individually creating a single or multiple documents by use of storage means.

The document creation assisting method according to a first embodiment of the present invention is illustrated in FIG. 1, and comprises a client processing monitoring step S210 and an edit-input assisting service step S220.

The client processing monitoring step extracts a single or each of multiple terms from a writing field of a document being created by a user, and stores, in storage means, a terminology file D20 including a list of a single or multiple standard terms that are the single or multiple terms thus extracted.

For example, in the client processing monitoring step S210, a single or each of multiple terms is extracted from the writing field of the document being created by the user, and the terminology file including a list of a single or multiple standard terms that are the terms thus extracted is stored in the storage means at a predetermined timing.

The predetermined timing is, for example, every time the user saves the document, at regular intervals, or the like.

Alternatively, the client processing monitoring step S210 may comprise: monitoring the process in which the user creates the document; reading a single or each of multiple input code strings individually inputted through an input device at the time of confirming a single or each of multiple terms in the writing field of the document being created by the user; and storing, in the storage means, a character-string pair file D30 including a list of a single or multiple pairs of a standard term and an input code string associated with each other, the standard term being one of the confirmed terms, the input code string being a corresponding one of the single or multiple input code strings already inputted through the input device at the time of confirming the single or each of the multiple standard terms.

The client processing monitoring step S210 may comprise individually storing, in the storage means: the document file D10 for defining the document being created by the user; and the terminology file D20 including a list of a single or multiple standard terms that are a single or multiple terms individually extracted from the writing field of the document being created by the user.

The client processing monitoring step S210 may comprise storing, in the storage means, the terminology file D20 including a list of a single or multiple terms, as multiple standard terms, that do not completely match with any of multiple terms included in a prepared dictionary, among a single or multiple terms included in the writing field of the document being created by the user.

The document file D10, the terminology file D20, and the character-string pair file D30 are stored for each of the multiple users.

For example, each of the multiple document files D10, each of the multiple terminology files D20, and each of the multiple character-string pair files D30 are stored in association with a corresponding one of the multiple users.

The document file D10 is a data file for defining a document.

The terminology file D20 is a data file including a list of a single or multiple standard terms. A standard term is a term extracted from a writing field of a document being created by a user, and may comprise a coined word included in the writing field in the document, a term defined by the user, a term that is included in a writing field of the document while being not included in a dictionary prepared for proofreading or kana-kanji conversion, etc.

The character-string pair file D30 is a data file including a list of pairs of a standard term and an input code string associated with each other. An input code string is a code string already inputted by a user through an input device at the time of confirming the associated standard term, and may comprise an ASCII code string, an alphabet character string, a half-size katakana character string, a katakana character string, a hiragana character string, or the like.

For example, a standard term is “ [symbol] [symbol] ” (“Global Monitor” in Japanese characters) and a corresponding input code string is “guro-barumonita”.

The edit-input assisting service step S220 comprises: extracting a term from the writing field of the document being created by the user; reading out a single or multiple standard terms each completely or partially matching with the extracted term, from the terminology file stored in the storage means; and teaching the user the presence of the read-out standard terms.

Here, complete matching indicates a case where, in a comparison, two character strings completely match with each other in terms of the number and order of characters. Here, partial matching indicates a case where, in a comparison, two character strings partially match with each other.

For example, teaching the user the presence of the read-out standard terms may comprise displaying, for the user, a graphic indicating the presence of the read-out standard terms.

The graphic may add a highlight or an underline to the extracted term while the document is displayed, for example.

As an alternative to displaying the graphic, the read-out standard terms may be displayed for the user.

The standard terms may be displayed in a newly-displayed window while the document is displayed, for example. This display may be in descending order of the number of characters in the partially-matching part.

The edit-input assisting service step S220 may comprise: monitoring the process in which the user creates the document; extracting a term from the writing field of the document being created; reading out a single or multiple standard terms each completely or partially matching with the extracted term, from the terminology file stored in the storage means; and teaching the user the presence of the standard terms.

For example, teaching the user the presence of the read-out standard terms may comprise displaying, for the user, a graphic indicating the presence of the read-out standard terms.

The graphic may add a highlight or an underline to the extracted term while the document is displayed, for example.

As an alternative to displaying the graphic, the read-out standard terms may be displayed for the user.

The standard terms may be displayed in a newly-displayed menu window while the document is displayed, for example.

The edit-input assisting service step S220 may comprise: monitoring the process in which the user creates the document; reading an input code string already inputted by the user through an input device at the time of confirming a term included in the writing field of the document; reading out, from the character-string pair file D30 stored in the storage means, a single or multiple input code strings each completely or partially matching with the read input code string; and teaching the user the presence of the standard terms associated respectively with the read-out input code strings.

A term may be completed upon input of an input code string by the user through the input device. In this way, standard terms are narrowed down upon completion of the input code string.

The method of teaching the presence of the standard terms is the same as described above, and hence the description thereof is not repeated.

The edit-input assisting service step S220 may comprise: storing a development history file D40 including a list of a single or multiple terms that are included in the single or multiple standard terms taught to the user and are adopted as terms in the writing field of the document by the user; comparing, at a predetermined timing, each of the adopted terms included in the development history file D40 and the standard terms included in the terminology file D20 stored in the storage means; and teaching the user the presence of the adopted terms when no pair of an adopted term and a standard term completely matching with each other is found.

For example, teaching the user the presence of the adopted terms may comprise displaying a graphic indicating the presence of the adopted terms when no pair of an adopted term and a standard term completely matching with each other is found.

The predetermined timing may be a timing at which the user inputs the input code string through the input device, for example.

The graphic may add a highlight or an underline to the adopted terms while the document is displayed, for example.

Alternatively, the edit-input assisting service step S220 may comprise: storing the development history file D40 including a list of pairs of an adopted term and an input code string associated with each other, the adopted term being one of the single or multiple standard terms taught to the user and being one of the single or multiple terms adopted as terms included in the document by the user, the input code string being one of the single or multiple input code strings already individually inputted through the input device at the time of confirming the corresponding one of the single or multiple adopted terms; comparing, at a predetermined timing, each of the adopted terms included in the development history file D40 and the standard terms included in the terminology file D20 stored in the storage means; and teaching the user the presence of the adopted terms when no pair of an adopted term and a standard term completely matching with each other and associated respectively with input code strings completely or partially matching with each other is found.

The method of teaching the user the presence of the adopted terms is the same as described above, and hence the description thereof is not repeated.

The edit-input assisting service step S220 may comprise: calculating, for the single or each of the multiple standard terms included in the terminology file D20 stored in the storage means, an evaluation value by using a predetermined evaluation function, on the basis of a mode of the standard term appearing in the writing field of the document, the mode being defined in the document file D10 stored in the storage means; storing the development history file D40 including a list of pairs of an adopted term and the evaluation value of each corresponding standard term associated with each other, the adopted term being one of the single or multiple standard terms taught to the user and being the term adopted in the writing field of the document by the user; comparing, at a predetermined timing, each of the adopted terms included in the development history file D40 and the standard terms included in the terminology file D20 stored in the storage means; and teaching the user the presence of the adopted term when the two evaluation values associated respectively with the adopted term and the standard term matching completely with each other do not agree with each other.

The method of teaching the user the presence of the adopted term is the same as described above, and hence the description thereof is not repeated.

The evaluation function calculates an evaluation value for the single or each of the multiple standard terms on the basis of the mode of the standard term appearing in the writing field of the document and defined in the document file stored in the storage means.

In one approach, the evaluation function calculates, for the single or each of the multiple standard terms, an evaluation value corresponding to the position at which the standard term appears in the order of the single or multiple standard terms in the document when counted from the start of the text included in the document.

An evaluation value “1” indicates a standard term appearing first when the order of the multiple standard terms is counted from the start of the text included in the document, for example.

In another approach, the evaluation function calculates, for the single or each of the multiple standard terms, an evaluation value corresponding to the frequency at which the standard term appears in the document.

An evaluation value “1” indicates a term appearing most frequently in the document among the multiple standard terms, for example.

In yet another approach, the evaluation function calculates evaluation values by using an evaluation value table manually set by the user.

A document creation assisting method of assisting multiple users to create multiple documents respectively by using storage means will now be described.

Assume that the method is for assisting three users (called a “user A,” a “user B”, and a “user C”) to create documents, respectively. Descriptions will be given of a relation between a client processing monitoring step S210 and an edit-input assisting service step S220 in this case.

For example, the client processing monitoring step S210 comprises: extracting a single or each of multiple terms from a writing field of a document A being created by the user A, and storing, in the storage means, a terminology file D20 in association with the user A, the terminology file D20 including a list of a single or multiple standard terms that are the single or multiple terms thus extracted; extracting a single or each of multiple terms from a writing field of a document B being created by the user B, and storing, in the storage means, a terminology file D20 in association with the user B, the terminology file D20 including a list of a single or multiple standard terms that are the single or multiple terms thus extracted; and extracting a single or each of multiple terms from a writing field of a document C being created by the user C, and storing, in the storage means, a terminology file D20 in association with the user C, the terminology file D20 including a list of a single or multiple standard terms that are the single or multiple terms thus extracted.

The edit-input assisting service step S220 may comprise: extracting a term from the writing field of the document A being created by the user A, reading out a single or multiple standard terms each completely or partially matching with the extracted term, from the terminology file D20 associated with the user A, the terminology file D20 associated with the user B, and the terminology file D20 associated with the user C, which are stored in the storage means, and teaching the user A the presence of the single or multiple standard terms thus read out; extracting a term from the writing field of the document B being created by the user B, reading out a single or multiple standard terms each completely or partially matching with the extracted term, from the terminology file D20 associated with the user A, the terminology file D20 associated with the user B, and the terminology file D20 associated with the user C, which are stored in the storage means, and teaching the user B the presence of the single or multiple standard terms thus read out; and extracting a term from the writing field of the document C being created by the user C, reading out a single or multiple standard terms each completely or partially matching with the extracted term, from the terminology file D20 associated with the user A, the terminology file D20 associated with the user B, and the terminology file D20 associated with the user C, which are stored in the storage means, and teaching the user C the presence of the single or multiple standard terms thus read out.

For example, the file associated with the user A is readable and writable for the user A, while being only readable for the user B and the user C. Similarly, the file associated with the user B is readable and writable for the user B, while being only readable for the user A and the user C, and the file associated with the user C is readable and writable for the user C, while being only readable for the user A and the user B.

A document creation assisting method of assisting a single user to create a single document by using storage means will now be described.

Assume that the method is for assisting a single user (called a “user A”) to create a document. Descriptions will be given of a relation between a client processing monitoring step S210 and an edit-input assisting service step S220 in this case.

For example, the client processing monitoring step S210 comprises extracting a single or each of multiple terms from a writing field of a document A being created by the user A, and storing, in the storage means, a terminology file in association with the user A, the terminology file including a list of a single or multiple standard terms that are the single or multiple terms thus extracted.

The edit-input assisting service step S220 may comprise extracting a term from the writing field of the document A being created by the user A, reading out a single or multiple standard terms each completely or partially matching with the extracted term, from the terminology file associated with the user A and stored in the storage means, and teaching the user A the presence of the single or multiple standard terms thus read out.

A development history file D40 is stored for each of multiple users.

The development history file D40 is a data file including a list of a single or multiple adopted terms. An adopted term is a term adopted by a user as a term in a writing field of a document, among a single or multiple standard terms taught to the user.

The development history file D40 may be a data file including a list of a single or multiple adopted terms and a single or multiple input data strings associated with each other. An input data string is a code string already inputted by a user through an input device at the time of confirming an adopted term associated with the input data string.

The development history file D40 may be a data file including a list of a single or multiple adopted terms, a single or multiple input data strings, and a single or multiple evaluation values associated with each other. An evaluation value is a value calculated for a single or each of multiple standard terms included in a terminology file stored in storage means, by using a predetermined evaluation function on the basis of a mode of the standard term appearing in a writing field of a document, the mode being defined in a document file stored in the storage means.

Referring now to FIG. 2, a second embodiment of a document creation assisting method is illustrated.

The document creation assisting method according to the second embodiment of the present invention comprises a client processing monitoring step S210, an edit-input assisting service step S220, and a shared-buffer managing step S230.

The client processing monitoring step S210 comprises: extracting a single or each of multiple terms from a writing field of a document being created by a user; and storing, in storage means, a terminology file including a list of a single or multiple standard terms that are the single or multiple terms thus extracted.

Since the client processing monitoring step S210 is the same as that in the first embodiment, the description thereof is not repeated.

The edit-input assisting service step S220 comprises: extracting a term from the writing field of the document being created by the user; reading out a single or multiple standard terms each completely or partially matching with the extracted term, from the terminology file stored in the storage means; and teaching the user the presence of the read-out standard terms.

Since the edit-input assisting service step S220 is the same as that in the first embodiment, the description thereof is not repeated.

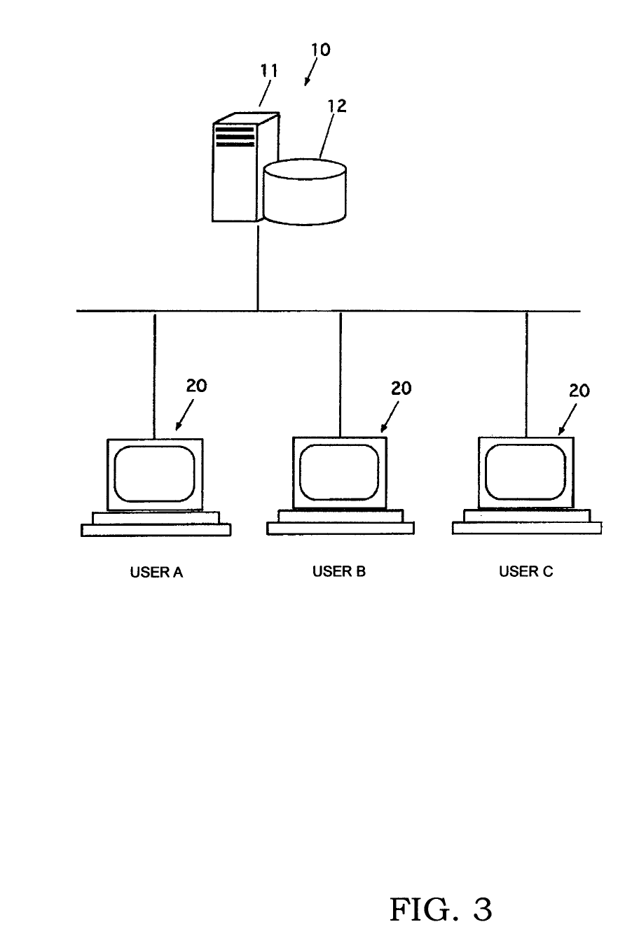

The shared-buffer managing step S230 comprises storing a terminology file D20 in a shared buffer 12 (which is illustrated in FIG. 3).

The shared-buffer managing step S230 may comprise storing the terminology file D20 and a character-string pair file D30 in the shared-buffer 12.

The shared-buffer managing step S230 may comprise storing a document file D10, the terminology file D20, and the character-string pair file D30 in the shared-buffer 12.

The shared buffer 12 is storage means that multiple users can access.

For example, the shared buffer 12 stores therein a document file D10, a terminology file D20, and a character-string pair file D30 that are associated with a user A, a document file D10, a terminology file D20, and a character-string pair file D30 that are associated with a user B, and a document file D10, a terminology file D20, and a character-string pair file D30 that are associated with a user C.

Next, a document creation assisting system according to an embodiment of the present invention will be described with reference to the drawings.

FIG. 3 is a schematic diagram showing the document creation assisting system according to one embodiment of the present invention.

The document creation assisting system is used together with the document processing system. For example, a single system may function as both the document creation assisting system and the document processing system.

The document creation assisting system may comprise client processing monitoring means and edit-input assisting means, and may further comprise a shared-buffer managing means.

The document creation assisting system comprises multiple computers 20 assigned respectively to multiple users. The multiple computers 20 are connected to each other by a telecommunication network so as to be able to communicate with each other.

The document creation assisting system may further comprise a collaboration framework 10. The collaboration framework 10 may comprise a server 11 and the shared buffer 12. The multiple computers 20 and the collaboration framework 10 may be connected to each other by a telecommunication network so as to be able to communicate with each other.

Each of the computers 20 is installed with a program, and implements a client processing monitoring function and an edit-input assisting function.

Moreover, the server 11 is installed with a program, and implements a shared-buffer managing function.

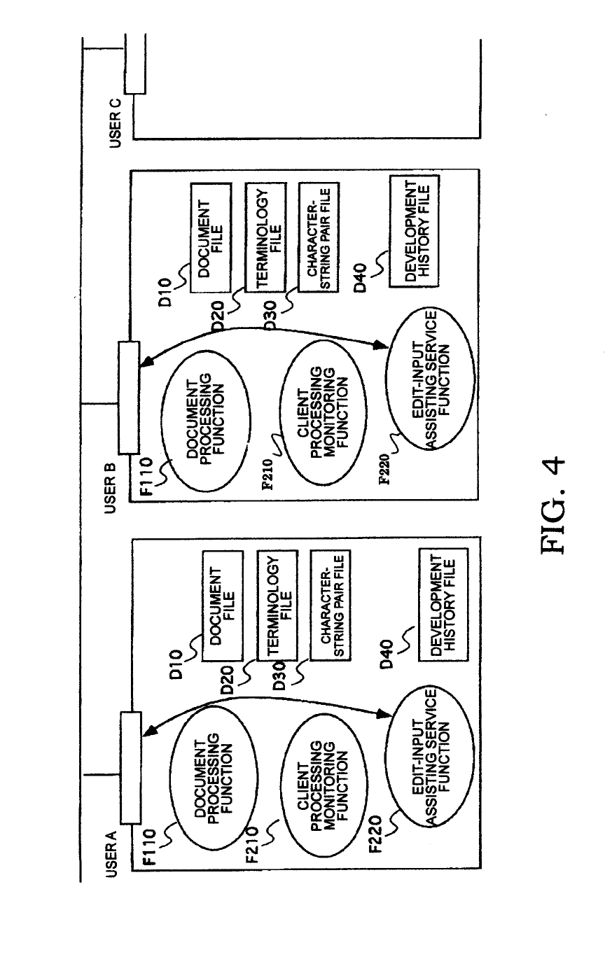

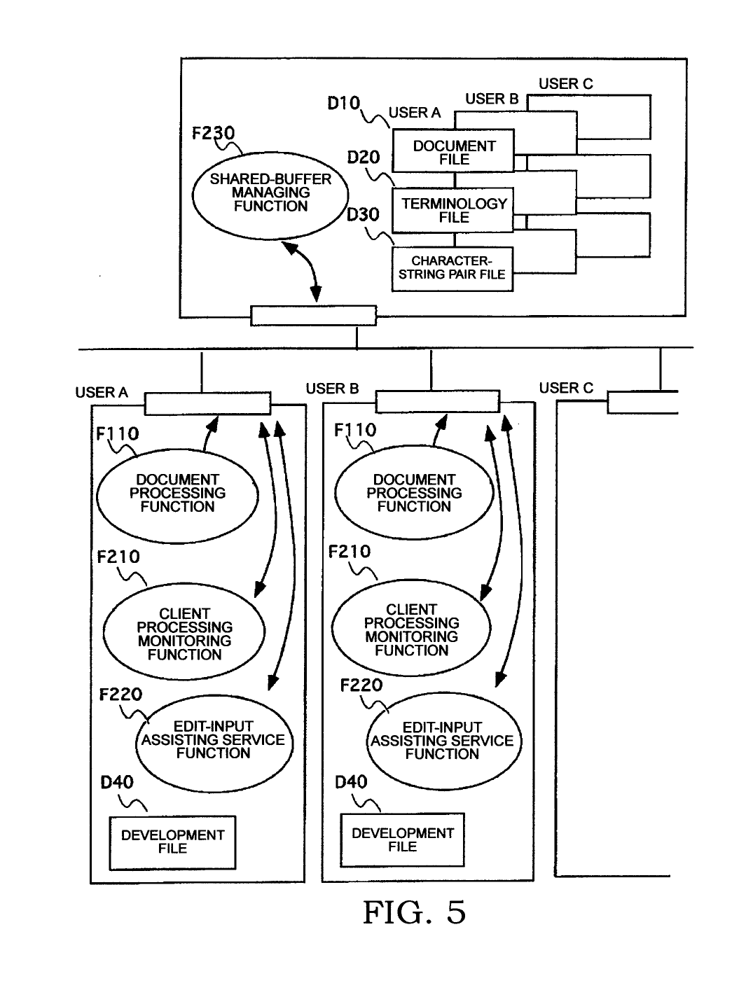

Next, a document creation assisting program according to embodiments of the present invention will be described with reference to FIGS. 4 and 5.

The document creation assisting program is used in parallel with a document processing program. The document processing program causes a computer to implement a document processing function F110.

The document creation assisting program is a program for assisting a single or multiple users to create a single or multiple documents, respectively.

A document creation assisting program according to a first embodiment of the present invention is illustrated in FIG. 4, and will now be described.

The document creation assisting program according to the first embodiment causes a computer including storage means to implement a client processing monitoring function F210 and an edit-input assisting service function F220.

The client processing monitoring function F210 comprises: extracting a single or each of multiple terms from a writing field of a document being created by a user; and storing, in the storage means, a terminology file including a list of a single or multiple standard terms that are the single or multiple terms thus extracted.

For example, implementation of the client processing monitoring function F210 comprises: extracting a single or each of multiple terms from the writing field of the document being created by the user; and storing, in the storage means, the terminology file including a list of a single or multiple terms that are extracted at a predetermined timing. The predetermined timing is, for example, every time the user saves the document, at regular intervals, or the like.

The implementation of the client processing monitoring function F210 may comprise: monitoring a process in which the user creates the document; reading a single or each of multiple input code strings already individually inputted through an input device at the time of confirming a single or each of multiple terms in the writing field of the document being created by the user; and storing, in the storage means, a character-string pair file including a list of a single or multiple pairs of a standard term and an input code string associated with each other, the standard term being one of the confirmed terms, the input code string being a corresponding one of the single or multiple input code strings already inputted through the input device at the time of confirming the single or each of the multiple standard terms.

For example, in the client processing monitoring function F210, an input code string already inputted through the input device at the time of confirming a term is read by hooking into processing performed by the computer implementing the document processing function F110.

The client processing monitoring function F210 may comprise: individually storing, in the storage means: the document being created by the user; and the terminology file including a list of a single or multiple standard terms that are a single or multiple terms individually extracted from the writing field of the document being created by the user.

The client processing monitoring function F210 may comprise storing, in the storage means, a terminology file including a list of a single or multiple terms, as multiple standard terms, that do not completely match with any of multiple terms included in a prepared dictionary, among a single or multiple terms included in the writing field of the document being created by the user.

A document file D10, a terminology file D20, and a character-string pair file D30 are stored for each of the multiple users. These files were described above with reference to FIGS. 1 and 2.

The edit-input assisting service function F220 comprises: extracting a term from the writing field of the document being created by the user; reading out a single or multiple standard terms each completely or partially matching with the extracted term, from the terminology file stored in the storage means; and teaching the user the presence of the read-out standard terms.

Here, complete matching indicates a case where, in a comparison, two character strings completely match with each other in terms of the number and order of characters.

Here, partial matching indicates a case where, in a comparison, two character strings partially match with each other.

For example, teaching the user the presence of the read-out standard terms may comprise displaying, for the user, a graphic indicating the presence of the read-out standard terms.

The graphic may add a highlight or an underline to the extracted term while the document is displayed, for example.

As an alternative to displaying the graphic, the read-out standard terms may be displayed for the user.

The standard terms may be displayed in a newly-displayed window while the document is displayed, for example.

The edit-input assisting service function F220 may include: monitoring the process in which the user creates the document; extracting a term from the writing field of the document being created; reading out a single or multiple standard terms each completely or partially matching with the extracted term, from the terminology file D20 stored in the storage means; and teaching the user the presence of the standard terms.

For example, teaching the user the presence of the standard terms may comprise displaying, for the user, a graphic indicating the presence of the read-out standard terms.

The graphic may add a highlight or an underline to the extracted term while the document is displayed, for example.

As an alternative to displaying the graphic, the read-out standard terms may be displayed for the user.

The standard terms may be displayed in a newly-displayed window while the document is displayed, for example.

The edit-input assisting service function F220 may comprise: monitoring the process in which the user creates the document; reading an input code string already inputted by the user through an input device at the time of confirming a term included in the writing field of the document; reading out, from the character-string pair file D30 stored in the storage means, a single or multiple input code strings each completely or partially matching with the read input code string; and teaching the user the presence of the standard terms associated respectively with the read-out input code strings.

The program for teaching the presence of the standard terms is the same as described above, and hence the description of the program is not repeated.

The edit-input assisting service function F220 comprises: storing a development history file D40 including a list of a single or multiple terms that are included in the single or multiple standard terms taught to the user and are adopted as terms in the writing field of the document by the user; comparing, at a predetermined timing, each of the adopted terms included in the development history file D40 and the standard terms included in the terminology file stored in the storage means; and teaching the user the presence of the adopted terms when no pair of an adopted term and a standard term completely matching with each other is found.

For example, teaching the user the presence of the adopted terms may comprise displaying a graphic indicating the presence of the adopted terms when no pair of an adopted term and a standard term completely matching with each other is found.

The graphic may add a highlight or an underline to the adopted terms while the document is displayed, for example.

Alternatively, the edit-input assisting service function F220 may comprise: storing the development history file D40 including a list of pairs of an adopted term and an input code string associated with each other, the adopted term being one of the single or multiple standard terms taught to the user and being one of the single or multiple terms adopted as terms included in the document by the user, the input code string being one of the single or multiple input code strings already individually inputted through the input device at the time of confirming the corresponding one of the single or multiple adopted terms; comparing, at a predetermined timing, each of the adopted terms included in the development history file D40 and the standard terms included in the terminology file stored in the storage means; and teaching the user the presence of the adopted terms when no pair of an adopted term and a standard term completely matching with each other and associated respectively with input code strings completely or partially matching with each other is found.

The program for teaching the user the presence of the adopted terms is the same as described above, and hence the description of the program is not repeated.

The edit-input assisting service function F220 may comprise: calculating, for the single or each of the multiple standard terms included in the terminology file D20 stored in the storage means, an evaluation value by using a predetermined evaluation function, on the basis of a mode of the standard term appearing in the writing field of the document, the mode being defined in the document file stored in the storage means; storing the development history file including a list of pairs of an adopted term and the evaluation value of each corresponding standard term associated with each other, the adopted term being one of the single or multiple standard terms taught to the user and being the term adopted in the writing field of the document by the user; comparing, at a predetermined timing, each of the adopted terms included in the development history file D40 and the standard terms included in the terminology file D20 stored in the storage means; and teaching the user the presence of the adopted term when the two evaluation values associated respectively with the adopted term and the standard term matching completely with each other do not agree with each other.

The program for teaching the user the presence of the adopted term is the same as described above, and hence the description of the program is not repeated.

The evaluation function calculates an evaluation value for the single or each of the multiple standard terms on the basis of the mode of the standard term appearing in the writing field of the document and defined in the document file D10 stored in the storage means.

In one approach, the evaluation function calculates, for the single or each of the multiple standard terms, an evaluation value corresponding to the position at which the standard term appears in the order of the single or multiple standard terms in the document when counted from the start of the texts included in the document.

In another approach, the evaluation function calculates, for the single or each of the multiple standard terms, an evaluation value corresponding to the frequency at which the standard term appears in the document.

In yet another approach, the evaluation function calculates evaluation values by using an evaluation value table manually set by the user.

A document creation assisting method of assisting multiple users to create multiple documents respectively by using storage means will now be described.

Assume that the method is for assisting three users (called a “user A,” a “user B”, and a “user C”) to create documents, respectively. Descriptions will be given of a relation between a client processing monitoring function F210 and an edit-input assisting service function F220 in this case.

For example, the client processing monitoring function F210 comprises: extracting a single or each of multiple terms from a writing field of a document A being created by the user A, and storing, in the storage means, a terminology file in association with the user A, the terminology file including a list of a single or multiple standard terms that are the single or multiple terms thus extracted; extracting a single or each of multiple terms from a writing field of a document B being created by the user B, and storing, in the storage means, a terminology file in association with the user B, the terminology file including a list of a single or multiple standard terms that are the single or multiple terms thus extracted; and extracting a single or each of multiple terms from a writing field of a document C being created by the user C, and storing, in the storage means, a terminology file in association with the user C, the terminology file including a list of a single or multiple standard terms that are the single or multiple terms thus extracted.

The edit-input assisting service function F220 may comprise: extracting a term from the writing field of the document A being created by the user A, reading out a single or multiple standard terms each completely or partially matching with the extracted term, from the terminology file associated with the user A, the terminology file associated with the user B, and the terminology file associated with the user C, which are stored in the storage means, and teaching the user A the presence of the single or multiple standard terms thus read out; extracting a term from the writing field of the document B being created by the user B, reading out a single or multiple standard terms each completely or partially matching with the extracted term, from the terminology file associated with the user A, the terminology file associated with the user B, and the terminology file associated with the user C, which are stored in the storage means, and teaching the user B the presence of the single or multiple standard terms thus read out; and extracting a term from the writing field of the document C being created by the user C, reading out a single or multiple standard terms each completely or partially matching with the extracted term, from the terminology file associated with the user A, the terminology file associated with the user B, and the terminology file associated with the user C, which are stored in the storage means, and teaching the user C the presence of the single or multiple standard terms thus read out.

A document creation assisting method of assisting a single user to create a single document by using storage means will now be described.

Assume that the method is for assisting a single user (called a “user A”) to create a document. Descriptions will be given of a relation between a client processing monitoring function F210 and an edit-input assisting service function F220 in this case.

For example, the client processing monitoring function F210 comprises extracting a single or each of multiple terms from a writing field of a document A being created by the user A, and storing, in the storage means, a terminology file in association with the user A, the terminology file including a list of a single or multiple standard terms that are the single or multiple terms thus extracted.

The edit-input assisting service function F220 may comprise extracting a term from the writing field of the document A being created by the user A, reading out a single or multiple standard terms each completely or partially matching with the extracted term, from the terminology file associated with the user A and stored in the storage means, and teaching the user A the presence of the single or multiple standard terms thus read out.

A development history file D40 is stored for each of multiple users, and was described above with reference to FIG. 1.

Referring now to FIG. 5, a second embodiment of a document creation assisting program is illustrated.

The document creation assisting program according to the second embodiment of the present invention causes a computer including storage means to implement a client processing monitoring function F210, an edit-input assisting service function F220, and a shared-buffer managing function F230.

The client processing monitoring function F210 comprises: extracting a single or each of multiple terms from a writing field of a document being created by a user; and storing, in storage means, a terminology file D20 including a list of a single or multiple standard terms that are the single or multiple terms thus extracted.

Since the client processing monitoring function F210 is the same as that in the first embodiment, the description thereof is not repeated.

The edit-input assisting service function F220 comprises: extracting a term from the writing field of the document being created by the user; reading out a single or multiple standard terms each completely or partially matching with the extracted term, from the terminology file stored in the storage means; and teaching the user the presence of the read-out standard terms.

Since the edit-input assisting service function F220 is the same as that in the first embodiment, the description thereof is not repeated.

The shared-buffer managing function F230 comprises storing a terminology file D20 in a shared buffer 12.

The shared-buffer managing function F230 may comprise storing the terminology file D20 and a character-string pair file D30 in the shared-buffer 12.

The shared-buffer managing function F230 may comprise storing a document file D10, the terminology file D20, and the character-string pair file D30 in the shared-buffer 12.

The shared buffer 12 is storage means that multiple users can access.

The shared buffer 12 stores therein a document file D10, a terminology file D20, and a character-string pair file D30 that are associated with a user A, a document file D10, a terminology file D20, and a character-string pair file D30 that are associated with a user B, and a document file D10, a terminology file D20, and a character-string pair file D30 that are associated with a user C.

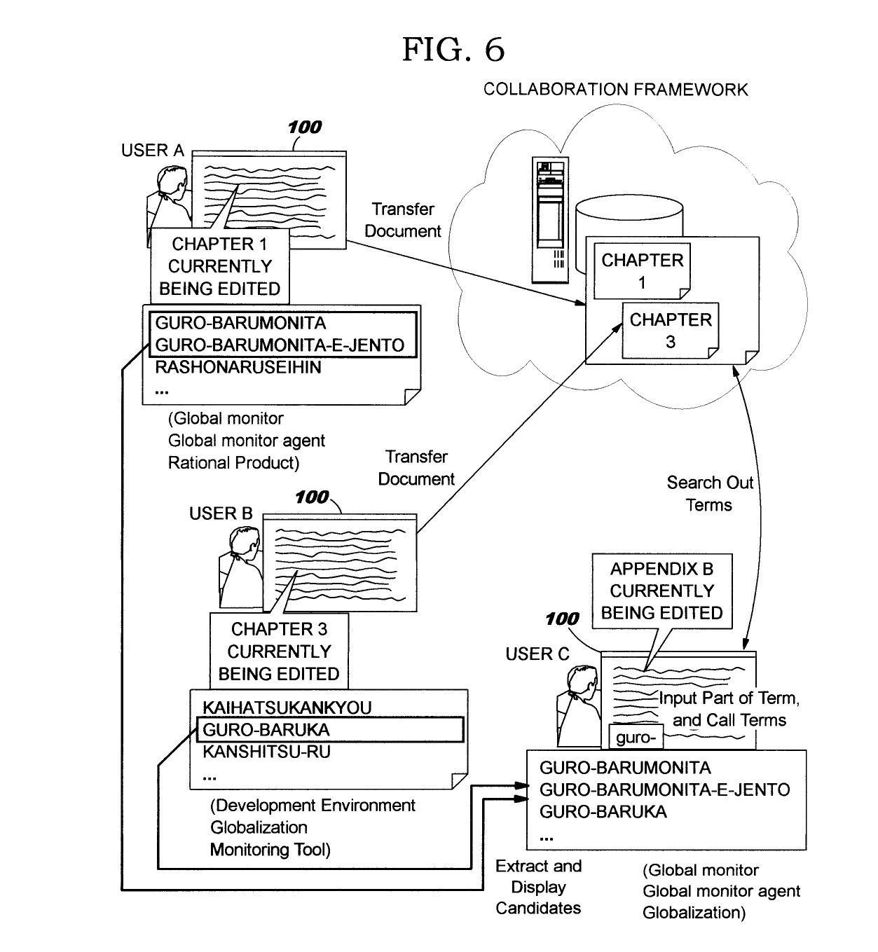

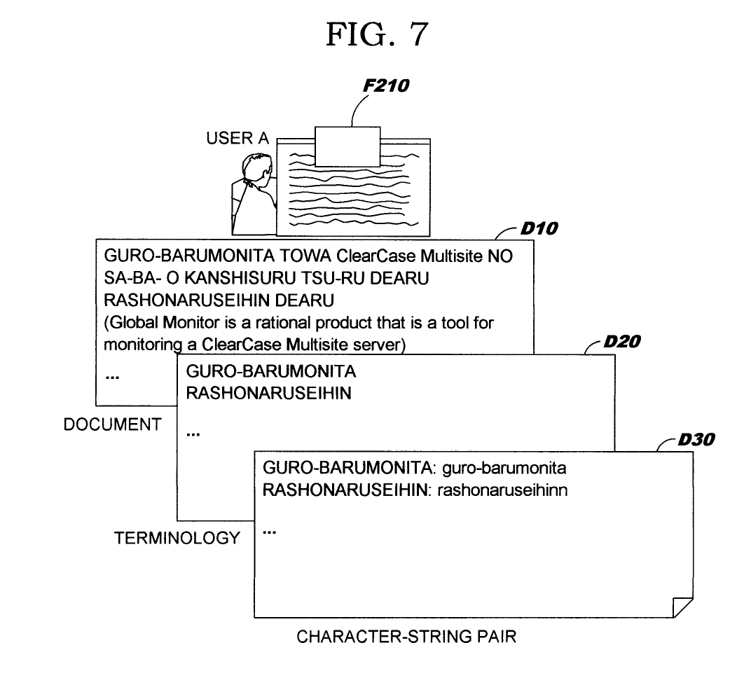

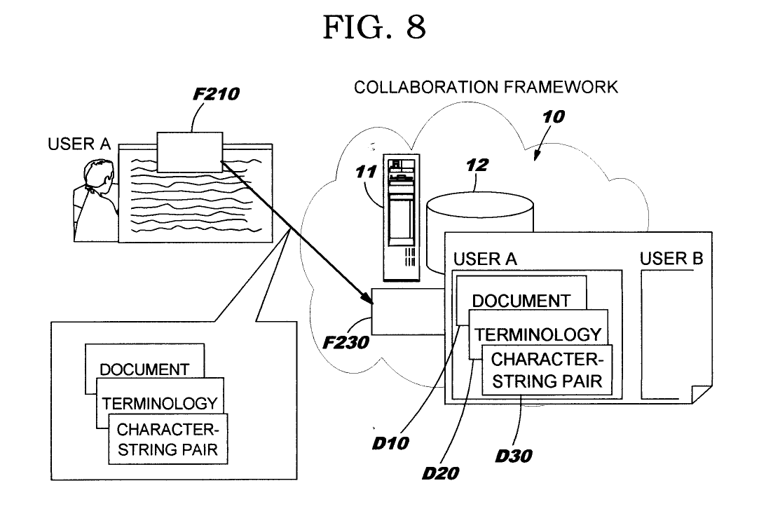

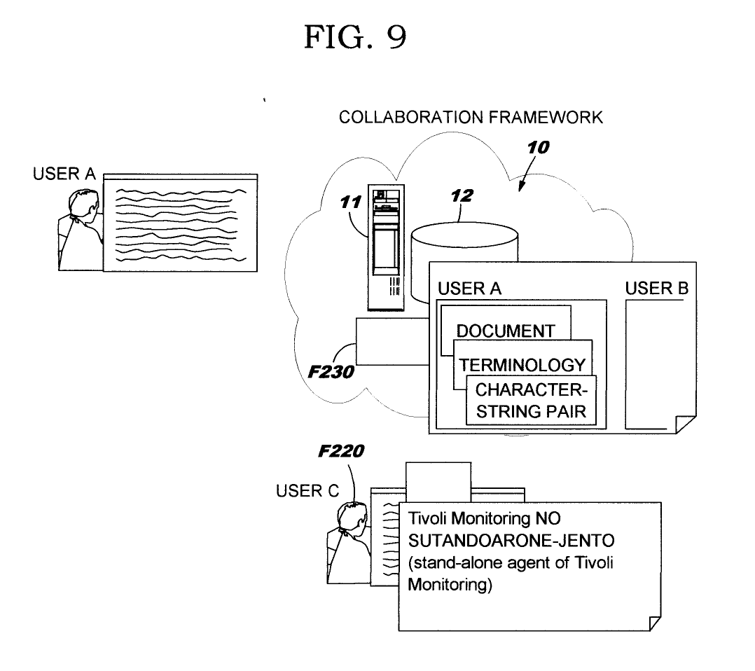

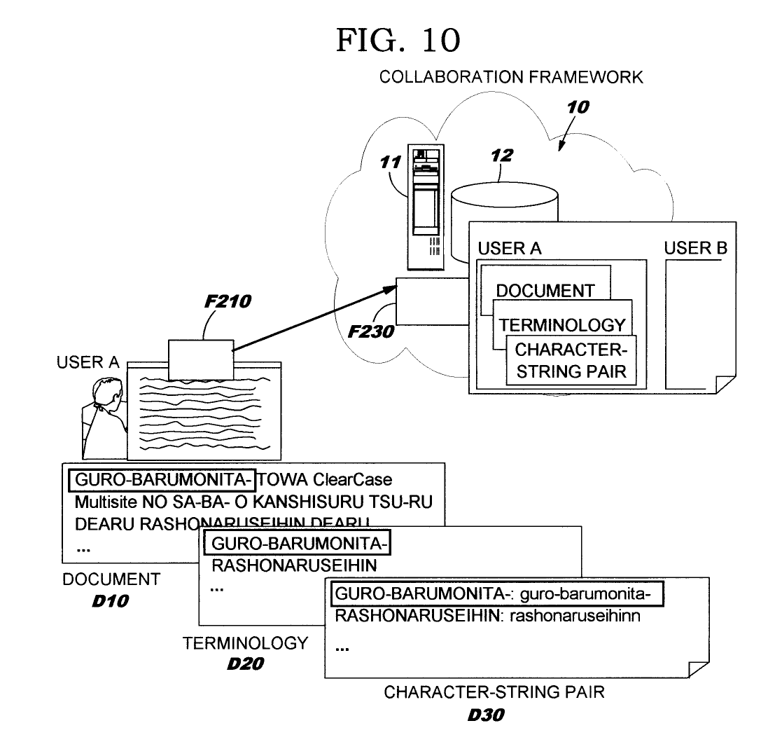

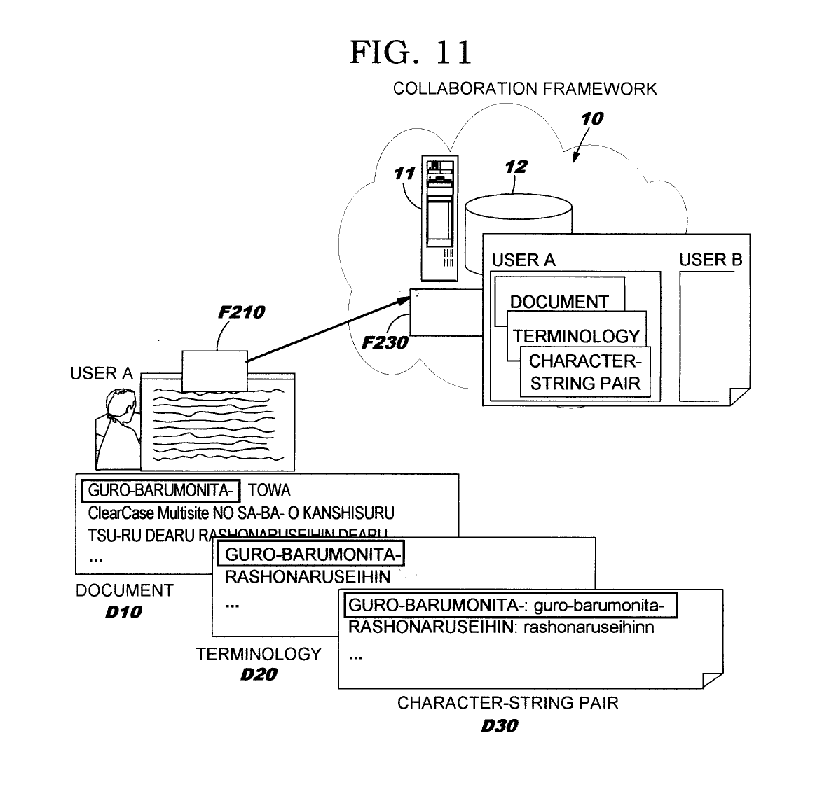

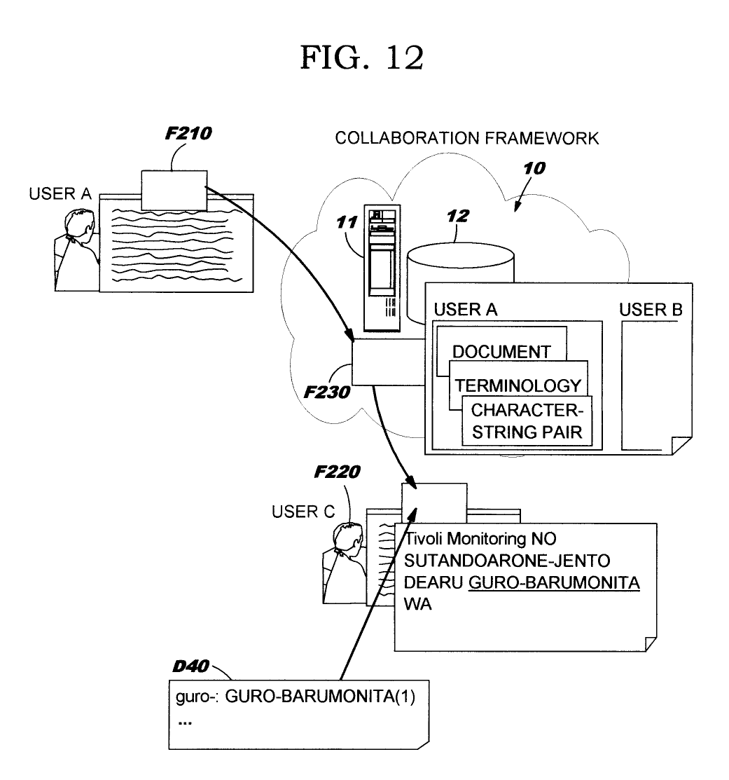

Operation of each of the document creation assisting methods, the document creation assisting system, and each of the document creation assisting programs according to the present invention will now be described on the basis of the drawings in FIGS. 6-12 by using a concrete example. Descriptions will be given by taking, as an example, a case in which the document creation assisting system that is a computer installed with the document creation assisting program performs the document creation assisting method.

For convenience of explanation, the descriptions will be given by assuming that, in a case where a user A, a user B, and a user C create a document in collaboration, the user A is in charge of Chapter 1, the user B is in charge of Chapter 3, and the user C is in charge of Appendix B.

In the following, described will be a case in which standard terms are extracted from a writing field of Chapter 1 of the document, created by the user A, and a term is adopted from the standard terms while the user C is creating a writing field of Appendix B of the document.

Processing 1: User A, input start

The user A enters an input for processing the writing field of Chapter 1 of the document by using a computer.

A computer 20 operated by the user A processes the writing field of Chapter 1 of the document by implementing a document processing function F110.

The computer 20 generates a document file D10 by implementing the document processing function F110.

In some cases, the computer 20 generates the document file D10 by implementing a client processing monitoring function F210.

The computer 20 extracts a term “ [symbol] [symbol] [symbol] ”(“global monitor” in Japanese characters) and a term “ [symbol] [symbol] ” (“rational product” in Japanese characters) from the writing field of the document, and generates a terminology file D20 including a list of these terms as standard terms, by implementing the client processing monitoring function F210.

The computer 20 generates a character-string pair file D30 including a list of a pair of the standard term “ [symbol] [symbol] [symbol] ” (“global monitor” in Japanese characters) and an input data string “guro-barumonita” associated with each other and a pair of the standard term “ [symbol] [symbol] ” (“rational product” in Japanese characters) and an input data string “rashonaruseihinn” associated with each other by implementing the client processing monitoring function F210.

Processing 2: Information transfer to shared buffer

The computer 20 used by the user A transfers the document file D10, the terminology file D20, and the character-string pair file D30 to a collaboration framework 10 by implementing the client processing monitoring function F210.

The collaboration framework 10 stores, in a shared buffer 12, the document file D10, the terminology file D20, and the character-string pair file D30 that are client information of the user A by implementing a shared-buffer managing function F230.

In addition, the collaboration framework 10 stores, in the shared buffer 12, a document file D10, a terminology file D20, and a character-string pair file D30 that are client information of the user B, and a document file D10, a terminology file D20, and a character-string pair file D30 that are client information of the user C by implementing the shared-buffer managing function F230.

Processing 3: User C, edit start

The user C enters an input for processing the writing field of Appendix B by using a computer 20.

The computer 20 processes the writing field of Appendix B of the document by implementing the document processing function F110.

Processing 4: Term development (completion)

The computer 20 operated by the user C monitors a process in which the user C creates the document, and reads an input code string “guro-” already inputted through an input device at the time of confirming a term in the writing field of the document being created by the user C, by implementing an edit-input assisting service function F220.

The computer 20 operated by the user C reads out, from the character-string pair file D30 of the user A stored in the shared buffer 12, an input code string “guro-barumonita” completely or partially matching with the input code string “guro-,” and displays the term “ [symbol] [symbol] [symbol] ” (“global monitor” in Japanese characters) s associated with the input code string “guro-barumonita” thus read out, in a newly-opened window for the user C.

FIG. 6 shows a state in which a term “ [symbol] [symbol] [symbol] [symbol] [symbol] ” (“global monitor agent” in Japanese characters) and a term “ [symbol] [symbol] ” (“globalization” in Japanese characters) extracted from the character-string pair file D30 are displayed in addition to the term “ [symbol] [symbol] [symbol] ” (“global monitor” in Japanese characters). See, for example, reference number 600.

The computer 20 operated by the user C replaces the input code string “guro-” in the writing field of the document with the term “ [symbol] [symbol] [symbol] ” (“global monitor” in Japanese characters) selected by the user C.

The computer 20 operated by the user C stores a development history file D40 including a list of the input code string “guro-” and the term “ [symbol] [symbol] [symbol] ” (“global monitor” in Japanese characters) associated with each other by implementing the edit-input assisting service function F220.

Further, the computer 20 operated by the user C refers to the document file D10 defined in a document file stored in the shared buffer 12, and thereby calculates an evaluation value of the term “ [symbol] [symbol] [symbol] ” (“global monitor” in Japanese characters) by use of an evaluation function, by implementing the edit-input assisting service function F220.

For example, since the term “ [symbol] [symbol] [symbol] ” (“global monitor” in Japanese characters) appears “first” in the order from the start of the texts in the writing field of the document of the user A, in the example, the computer 20 calculates that the evaluation value is “1”.

The computer 20 operated by the user C stores the development history file D40 including a list of the input code string “guro-”, the term “ [symbol] [symbol] [symbol] ” (“global monitor” in Japanese characters), and the evaluation value “1” associated with each other by implementing the edit-input assisting service function F220.

Processing 5: Term modification

Further, the user A enters an input for processing the writing field of Chapter 1 of the document by using the computer.

The user A changes the term “ [symbol] [symbol] [symbol] ” (“global monitor” in Japanese characters) in the writing field of Chapter 1 of the document to a term “ [symbol] [symbol] [symbol] ” (“global monitor” in Japanese characters with prolonged sound symbol).

The computer 20 generates the document file D10 by implementing the document processing function F110.

The computer 20 extracts the term “ [symbol] [symbol] [symbol] ” (“global monitor” in Japanese characters with prolonged sound symbol) and the term “ [symbol] [symbol] ” (“rational product” in Japanese characters)from the writing field of the document, and then generates the terminology file D20 including a list of the extracted terms as standard terms, by implementing the client processing monitoring function F210.

The computer 20 generates the character-string pair file D30 including a list of a pair of the standard term “ [symbol] [symbol] [symbol] ” (“global monitor” in Japanese characters with prolonged sound symbol) and an input data string “guro-barumonita-” associated with each other and a pair of the standard term “ [symbol] [symbol] ” (“rational product” in Japanese characters) and the input data string “rashonaruseihinn” associated with each other by implementing the client processing monitoring function F210.

The computer 20 used by the user A transfers the document file D10, the terminology file D20, and the character-string pair file D30 to the collaboration framework 10 by implementing the client processing monitoring function F210.

The collaboration framework 10 stores, in the shared buffer 12, the document file D10, the terminology file D20, and the character-string pair file D30 that are client information of the user A by implementing the shared-buffer managing function F230.

As a result, the standard term “ [symbol] [symbol] [symbol] ” (“global monitor” in Japanese characters) in the data included in the document file D10, the terminology file D20, and the character-string pair file D30 are deleted, and the standard term “ [symbol] [symbol] [symbol] ” (“global monitor” in Japanese characters with prolonged sound symbol) is newly added.

Processing 6: Automatic re-development, warning

The user C enters an input for processing the writing field of Appendix B of the document by using the computer 20.

The computer 20 processes the writing field of Appendix B of the document by implementing the document processing function F110.

The computer 20 operated by the user C compares the adopted term “ [symbol] [symbol] [symbol] ” (“global monitor” in Japanese characters) included in the development history file D40 and the standard term “ [symbol] [symbol] [symbol] ” (“global monitor” in Japanese characters with prolonged sound symbol) included in the terminology file D20 stored in the storage means, at a predetermined timing, finds out that there is no pair of the adopted term and a standard term completely matching with each other, and consequently teaches the user C the presence of the adopted term “ [symbol] [symbol] [symbol] ”(“global monitor” in Japanese characters) by implementing the edit-input assisting service function F220.

The computer 20 provides a warning to the user C by underlining the term “ [symbol] [symbol] [symbol] ” (“global monitor” in Japanese characters) in the writing field of the document being created by the user C.

The user C views the display, and changes the term “ [symbol] [symbol] [symbol] ” (“global monitor” in Japanese characters) in the document being created to the term “ [symbol] [symbol] [symbol] ” (“global monitor” in Japanese characters with prolonged sound symbol).

The document creation assisting method, the document creation assisting system, and the document creation assisting program according to embodiments of the present invention provide the following effects with the configurations.

A term extracted from a writing field of a document being created by a user is stored in a terminology file D20 as a standard term, and the presence of a standard term completely or partially matching with a term extracted from a writing field of a document being created by a user is taught to the user. With this configuration, the user can use the term consistently by referring to the standard term, the presence of which is thus taught.

Moreover, creation of a document by a user is monitored, and the presence of a standard term completely or partially matching with a term extracted from a writing field of the document being created is taught to the user. With this configuration, the user can use the term consistently by referring to the standard term, the presence of which is thus taught.

Further, creation of a document by a user by inputting an input code string through an input device and thereby confirming a term is monitored, a standard term and an input code string associated with each other are stored in a character-string pair file, an input code inputted by a user through an input device is read by monitoring the input process, an input code string completely or partially matching with the input code string thus read is read out from the character-string pair file, and the presence of the standard term associated with the input code string thus read out is taught to the user. With this configuration, the user can use the term consistently by referring to the standard term ,the presence of which is thus taught.

Further, a term adopted by a user as an adopted term from standard terms taught to the user is stored in a development history file D40, the adopted term thus stored and stored standard terms are compared at a predetermined timing, and the user is notified of the presence of the adopted term when no standard term completely matching with the adopted term is found. With this configuration, the user can use the term consistently by referring to the standard term no longer matching with the adopted term.

Further, an adopted term adopted by a user from standard terms taught to the user is stored in a development history file D40 as an adopted term in association with a code string already inputted at the time of confirming the adopted term, the adopted term thus stored and stored standard terms are compared at a predetermined timing, and the user is notified of the presence of the adopted term when no pair of the adopted term and a standard term completely matching with each other and associated respectively with input code strings completely or partially matching with each other is found. With this configuration, the user can use the term consistently by referring to the standard term no longer matching with the adopted term.

Further, a document being created by a user is stored, a term extracted from a writing field of the document being created by the user is stored in a terminology file as a standard term, an evaluation value is calculated for each standard term stored in the terminology file, on the basis of the mode in which the standard term appears in the writing field of the stored document, an adopted term adopted by the user from standard terms taught to the user and the evaluation value of the adopted term are stored in a development history file by being associated with each other, the adopted term thus stored and stored standard terms are compared at a predetermined timing, and the presence of the adopted term is taught to the user when the evaluation value associated with the adopted term and the evaluation value associated with a standard term, the adopted term, and the standard term completely matching with each other, do not match with each other. With this configuration, the user can use the term consistently by referring to the standard term, the evaluation value of which no longer matches with that of the adopted term.

Further, a term included in a writing field of a document being created by a user and not included in a dictionary is stored in a terminology file as a standard term. With this configuration, the term not included in a dictionary can be stored in a terminology file D20 as a standard term.

With these configurations, a document having a consistent use of terms as a whole can be completed when multiple users create the document in collaboration by taking charge, respectively, of sections of the document.

The present invention is not limited to the above-described embodiments, and various modifications can be made to the embodiments within the spirit of the invention.

Descriptions have been given above that a document file, a terminology file, a character-string pair file, and a development history file are stored in storage means. However, the configuration is not limited to this. For example, a document file, a terminology file, a character-string pair file, and a development history file may be stored in a memory.

1. A document creation assisting method of assisting a plurality of users to individually create one or more documents with consistent use of terms, the method comprising:
monitoring client processing during document creation, comprising:
extracting one or more terms from a writing field of a document created by a first user; and
storing the one or more extracted terms, as standard terms, in a terminology file; and
assisting with editing input during document creation, comprising:
extracting an input term from a writing field of a document being created by a second user;
locating, from the terminology file, the standard term that completely or partially matches the extracted input term; and
teaching the second user a presence of the located standard term.

2. The document creation assisting method according to claim 1, wherein:
the assisting further comprises monitoring a process in which the second user creates a document in order to extract the input term.

3. The document creation assisting method according to claim 1, wherein:
the monitoring further comprises:
monitoring a process in which the first user creates a document;
reading one or more input code strings already inputted through an input device at a time of confirming one or more terms in the writing field of the document being created by the first user; and
storing a character-string pair file, the character-string pair file comprising a list of the one or more standard terms and the one or more input code strings, in pair-wise association with each other, the one or more standard terms in the list being the one or more confirmed terms and the input code string associated with each of the confirmed terms having been confirmed as the standard term associated with that input code string;
extracting the input term further comprises extracting a newly-inputted input code string;
locating the standard term further comprises locating, from the character-string pair file, a selected one of the one or more standard terms in the list that is associated with a selected one of the input code strings that completely or partially matches the newly-inputted input code string; and
teaching the second user the presence of the located standard term comprises teaching the second user the presence of the located selected one of the standard terms.

4. The document creation assisting method according to claim 1, wherein:
the assisting further comprises:
storing, in a development history file, a list of one or more adopted terms, each of the adopted terms being one of the one or more standard terms for which the presence of the standard term has been taught to the user and has been adopted by the user as a term in the writing field of the document, responsive to the teaching;
comparing the one or more adopted terms in the list stored in the development history file and the one or more standard terms stored in the terminology file, at a predetermined timing; and
teaching the second user the presence of the located term comprises teaching the second user the presence of one of the adopted terms when no standard term completely matching the adopted term is found.

5. The document creation assisting method according to claim 4, wherein:
the assisting further comprises:
storing, for each of the adopted terms in the development history file, a list of one or more of the input code strings, in pair-wise association with each other, the one or more input code strings associated with each of the adopted terms comprising input code strings for which, responsive to input thereof, the user adopted the adopted term; and
teaching the second user the presence of one of the adopted terms is performed when no standard term that completely or partially matches the extracted input term is located in the terminology file and no standard term is located from the character-string pair file in association with a selected one of the input code strings that completely or partially matches the newly-inputted input code string.

6. The document creation assisting method according to claim 4, wherein:
the monitoring further comprises storing a document file, the document file defining the document created by the first user; and
the assisting further comprises:
calculating, for each of the one or more standard terms in the terminology file, an evaluation value of the standard term by using a predetermined evaluation function based on a mode of the standard term that is defined in the document file;
storing, in the development history file in association with each of the one or more adopted terms, the evaluation value calculated for each of the one or more standard terms for which the presence of the standard term has been taught to the user and has been adopted by the user, responsive to the teaching; and
teaching the second user the presence of one of the adopted terms comprises teaching the second user the presence of the one of the adopted terms when there is a standard term that matches the adopted term but the two evaluation values associated respectively with the adopted term and the standard term do not match each other.

7. The document creation assisting method according to claim 1, wherein:
the monitoring further comprises storing, in the terminology file as one or more of the standard terms, one or more non-matching terms, each of the non-matching terms comprising a term which is written in the writing field of the document created by the first user but which does not completely match with any of a plurality of terms in a dictionary prepared in advance.

8. A document creation assisting program for assisting a plurality of users to individually create one or more documents, the program embodied on at least one tangible computer-readable medium and causing a computer system including storage means to implement:
a client processing monitoring function of extracting one or more terms from a writing field of a document created by a user, and storing in the storage means a terminology file being a data file including a list of one or more standard terms that are the one or more terms thus extracted; and
an edit-input assisting service function of extracting a term from a writing field of a document created by a user, reading out the standard term completely or partially matching with the extracted term, from the terminology file stored in the storage means, and teaching the user the presence of the standard term thus read out.

9. The document creation assisting program according to claim 8, wherein
the edit-input assisting service function includes monitoring a process in which a user creates a document, extracting a term from a writing field of the document being created, reading out the standard term completely or partially matching with the extracted term, from the terminology file stored in the storage means, and teaching the user the presence of the standard term.

10. The document creation assisting program according to claim 9, wherein
the client processing monitoring function includes monitoring a process in which a user creates a document, reading one or more input code strings already inputted through an input device at a time of confirming one or more terms in the writing field of the document being created by the user, and storing in the storage means a character-string pair file being a data file including a list of the one or more standard terms and the one or more input code strings associated with each other, the one or more standard terms being the one or more confirmed terms, the one or more input code strings already inputted through the input device at the time of confirming the one or more standard terms, and
the edit-input assisting service function includes monitoring a process in which a user creates a document, reading an input code string already inputted by a user through an input device at a time of confirming a term in a writing field of the document, reading out the input code string completely or partially matching with the input code string thus read, from the character string pair file stored in the storage means, and teaching the user the presence of the standard term associated with the input code string thus read out.

11. The document creation assisting program according to claim 10, wherein
the edit-input assisting service function includes storing a development history file being a data file including a list of one or more adopted terms that are the one or more standard terms each taught to the user and adopted by the user as a term in the writing field of the document, comparing the one or more adopted terms included in the development history file and the one or more standard terms included in the terminology file stored in the storage means, at a predetermined timing, and teaching the user the presence of an adopted term when no standard term completely matching with the adopted term is found.

12. The document creation assisting program according to claim 11, wherein
the edit-input assisting service function includes storing a development history file being a data file including a list of one or more adopted terms and the one or more input code strings associated with each other, the one or more adopted terms being the one or more standard terms each taught to the user and adopted by the user as a term in the writing field of the document, the one or more input code strings already inputted through the input device at the time of confirming the one or more adopted terms, comparing the one or more adopted terms in the development history file and the one or more standard terms in the terminology file stored in the storage means, at a predetermined timing, and teaching the user the presence of an adopted term when no standard term completely matching with the adopted term is found among the standard terms associated with the input code strings completely or partially matching with the input code string of the adopted term.

13. The document creation assisting program according to claim 12, wherein
the client processing monitoring function includes storing in the storage means a document file being a data file defining the document created by the user and a terminology file being a data file including the list of the one or more standard terms that are the one or more terms extracted from the writing field of the document created by the user, and
the edit-input assisting service function includes calculating, for each of the one or more standard terms in the terminology file stored in the storage means, an evaluation value of the standard term by using a predetermined evaluation function on the basis of a mode of the standard term that is defined in the document file in the storage means and appears in the writing field of the document, storing a development history file being a data file including a list of the one or more adopted terms and the one or more evaluation values of the one or more standard terms corresponding respectively to the one or more adopted terms, in association with each other, the one or more adopted terms being the one or more standard terms taught to the user and adopted by the user in the writing field of the document, comparing the one or more adopted terms stored in the development history file and the one or more standard terms included in the terminology file stored in the storage means, at a predetermined timing, and teaching the user the presence of an adopted term when there is a standard term matching with the adopted term, and when the two evaluation values associated respectively with the adopted term and the standard term do not match with each other.

14. The document creation assisting program according to claim 13, wherein
the client processing monitoring function includes storing in the storage means a terminology file being a data file including a list of one or more terms, as the one or more standard terms, each of which is a term written in the writing field of the document created by the user and not completely matching with any of terms in a dictionary prepared in advance.

15. The document creation assisting program according to claim 8, wherein
the edit-input assisting service function includes storing a development history file being a data file including a list of one or more adopted terms that are the one or more standard terms each taught to the user and adopted by the user as a term in the writing field of the document, comparing the one or more adopted terms included in the development history file and the one or more standard terms included in the terminology file stored in the storage means, at a predetermined timing, and teaching the user the presence of an adopted term when no standard term completely matching with the adopted term is found.

16. The document creation assisting program according to claim 8, wherein
the edit-input assisting service function includes storing a development history file being a data file including a list of one or more adopted terms and the one or more input code strings associated with each other, the one or more adopted terms being the one or more standard terms each taught to the user and adopted by the user as a term in the writing field of the document, the one or more input code strings already inputted through the input device at the time of confirming the one or more adopted terms, comparing the one or more adopted terms in the development history file and the one or more standard terms in the terminology file stored in the storage means, at a predetermined timing, and teaching the user the presence of an adopted term when no standard term completely matching with the adopted term is found among the standard terms associated with the input code strings completely or partially matching with the input code string of the adopted term.

17. The document creation assisting program according to claim 8, wherein
the client processing monitoring function includes storing in the storage means a document file being a data file defining the document created by the user and a terminology file being a data file including the list of the one or more standard terms that are the one or more terms extracted from the writing field of the document created by the user, and
the edit-input assisting service function includes calculating, for each of the one or more standard terms in the terminology file stored in the storage means, an evaluation value of the standard term by using a predetermined evaluation function on the basis of a mode of the standard term that is defined in the document file in the storage means and appears in the writing field of the document, storing a development history file being a data file including a list of the one or more adopted terms and the one or more evaluation values of the one or more standard terms corresponding respectively to the one or more adopted terms, in association with each other, the one or more adopted terms being the one or more standard terms taught to the user and adopted by the user in the writing field of the document, comparing the one or more adopted terms stored in the development history file and the one or more standard terms included in the terminology file stored in the storage means, at a predetermined timing, and teaching the user the presence of an adopted term when there is a standard term matching with the adopted term, and when the two evaluation values associated respectively with the adopted term and the standard term do not match with each other.

18. A document creation assisting system for assisting a plurality of users to individually create one or more documents with consistent user of terms, the system comprising:
a computer comprising a processor; and
instructions which are executable, using the processor, to perform functions comprising:
monitoring client processing during document creation, comprising:
extracting one or more terms from a writing field of a document created by a first user; and
storing the one or more extracted terms, as standard terms, in a terminology file; and
assisting with editing input during document creation, comprising:
extracting an input term from a writing field of a document being created by a second user;
locating, from the terminology file, the standard term that completely or partially matches the extracted input term; and
teaching the second user a presence of the located standard term.
